(19) United States
(12) Patent Application Publication
(10) Pub. No.: US 2026/0323648 A1
(43) Pub. Date: Oct. 15, 2026

(54) IMPROVING PDSCH THROUGHPUT BY REDUCING NACK2ACK

(71) Applicant: Telefonaktiebolaget LM Ericsson (publ), Stockholm (SE)

(72) Inventors: Qingchao LIU, Ottawa (CA); Pierre COLL, Gatineau (CA)

(73) Assignee: Telefonaktiebolaget LM Ericsson (publ), Stockholm (SE)

(21) Appl. No.: 19/478,262

(22) PCT Filed: Apr. 28, 2023
(86) PCT No.: PCT/IB2023/054474

§ 371 Date: Oct. 24, 2025

(51) Int. Cl. H04W 72/21; H04L 1/1812; H04W 72/23; H04W 76/28

(52) U.S. Cl. CPC H04W 72/21; H04L 1/1812; H04W 72/23; H04W 76/28

(57) ABSTRACT

Various embodiments described herein provide for improvements to the small block decoder used for format 3 Physical Uplink Control Channel (PUCCH) decoding for 3 to 11 bits to improve the Physical Downlink Shared Channel (PDSCH) throughput. Two decoding metrics are used to control the downlink (DL) Hybrid Automatic Repeat Request (HARQ) bits decoding performance related to Block Error Rate (BLER), ackmiss, nack2ack, and dtx2ack, to align the 1% ackmiss target signal to noise ratio (SNR) with 0.1% nack2ack SNR value. By presimulating the decoding metric thresholds, the nack2ack SNR value to meet the 0.1% requirement will be significantly reduced.

### TECHNICAL FIELD

The present disclosure relates to methods for improving Physical Downlink Shared Channel throughput by reducing nack2ack in a wireless communication system.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

New Radio (NR) Downlink (DL) Carrier Aggregation (CA) allows a User Equipment (UE) to significantly increase its DL throughput by aggregating several carriers for its DL data transmission. To make effective use of the activated DL carriers, DL link adaptations on each carrier are needed to ensure the coding rate and beamforming are the best fit for the current radio channel conditions.

Hybrid Automatic Repeat Request (HARQ) is an essential component of Fifth Generation (5G) NR and key for NR DL carrier aggregations. The above DL link adaptations heavily rely on a UE's HARQ feedback reports for each DL carrier. The number of carrier components and Time Division Duplex (TDD) patterns can create a large HARQ feedback bundle within a UE report window. The HARQ feedback bits range can be in the range of 3 to 11bits.

A gNodeB (gNB) sends Downlink Control Information (DCI) on a Physical Downlink Control Channel (PDCCH) which carries scheduling information for uplink (UL) and downlink. It provides a UE with the necessary information for proper reception and decoding of the downlink data on a Physical Downlink Shared Channel (PDSCH) as well as transmitting the uplink data and UCI (Uplink Control Information) on a Physical Uplink Shared Channel (PUSCH) or UCI on a Physical Uplink Control Channel (PUCCH).

Link Adaptation (LA) is an important Radio Resource Management (RRM) function in wireless communication systems for reliable communication. The purpose of link adaptation is to determine the appropriate modulation and coding scheme (MCS) to maximize user throughput or data rate. In a typical system which utilizes HARQ, the task of LA is to determine the highest MCS for which the targeted operating point (e.g., block error rate (BLER) after certain number of HARQ transmissions) can be achieved. To perform link adaptation, information on the communication link quality is required. This may be obtained either from measurements at the transmitter or reports of Channel State Information (CSI) from receiver to transmitter. To achieve high throughput, LA may be performed in every transmission time interval (e.g., per slot).

As mentioned earlier, the DL link quality can be determined from reported CSI from UE. The methodology of evaluating link quality is not defined by Third Generation Partnership Project (3GPP) standards, and thus it varies from UE vendor to vendor. Some types of UEs may report optimistic CSI while other type of UEs may report pessimistic CSI. The CSI reported by UE is typically mapped to a channel quality measure by the transmitter (for example Signal to Interference and Noise Ratio (SINR)).

To accommodate systematic errors in Channel Quality Indicator (CQI) reporting from the UE and to track faster changes in channel conditions, a PDSCH outer-loop adjustment is normally used to generate an outer-loop adjustment OL_ADJ which is added to the PDSCH SINR estimation based on the CQI report. The overall estimated SINR based on CQI and outer-loop adjustment is used in determining the MCS. The outer-loop adjustment is calculated based on the PDSCH transmission result, which is determined by gNB. The transmission result could be a success, or failure.

For each DL transmission, the HARQ feedback result transmitted on either PUCCH or PUSCH could be:
PDSCH acknowledgment (ACK), when the UE successfully decodes both PDCCH and PDSCH, and sends ACK to a gNB;
PDSCH negative ACK (NACK), when the UE successfully decodes PDCCH but fails to decode PDSCH and sends NACK to gNB;
Discontinuous Transmission (DTX), when the UE fails to decode PDCCH and does not send any feedback to gNB.

If data decoding errors cannot be caught by HARQ with Code Block (CB) and Transport Block (TB) Cyclic Redundancy Check (CRC) protections or a false ACK (nack2ack, dtx2Ack), upper layer retransmissions will be triggered by such as layer 2 (ARQ) Automatic Repeat Request or by applications.

There are five different formats of PUCCH, and which one of them is used is determined by how many bits of information should be carried and how many symbols are assigned.

There currently exist certain challenge(s). With DL Carrier Aggregation (CA) and TDD carrier components, the bundled DL HARQ feedback bits will be in the range of 3 to 35 bits, depending on the number of carrier components and each carrier component's TDD pattern. Furthermore, the HARQ feedback from UE through gNB UL channels (PUCCH and PUSCH) will be vital to dictating the PDSCH transmissions and their re-transmissions. Hence, the HARQ feedback decoding performance dramatically impacts the PDSCH throughput and packet latency at application level.

If there is no UL traffic, PUCCH format 3 is often used to carry the HARQ feedback. PUCCH format 3 decoding performance is thus key to the success of the PDSCH transmissions. If the decoding performance can be improved by 1 or 2 dBs, the cell coverage can be extended, and the feedback will be more reliable.

When the PDSCH HARQ feedback bits are within 3 to 11 bits, small block encoder (size N=32) is used at transmitter and given by 3GPP TS 38.212 chapter 5.3.3.3. When this encoder is used, it does not have CRC to protect the validity of the decoding, and at receiver side we must find other way to improve the decoding efficiency and quality.

At the gNB receiver side for small block transmissions, there are in total 2\hat{ }A different codewords b_i (n), n=0, 1, . . . , N−1, where N=32 (block size), in the code book given by:

$${b}_{i} ( n ) = {\sum }_{m = 0}^{A - 1} ( {a}_{m} \cdot {M}_{n , m} ) mod 2 \qquad Eqn . 1$$

where aₘ∈{0, 1} is the binary representation of one bit and M_{n,m} are basis sequences specified in Table 5.3.3.3-1 of 3GPP TS 38.212.

Each codeword bᵢ(n), n=0, 1, . . . , N−1, in the code book is first mapped to bipolar form qᵢ(n) by qᵢ(n)=1-2bᵢ(n), n=0, 1, . . . , N−1.

The decision variable for codeword i, dᵢ, is given as a scalar product of the rate dematched soft values ŝ and the codeword qᵢ:

$${d}_{i} = {\sum }_{n = 0}^{N - 1} s ( n ) \cdot {q}_{i} ( n ) , \qquad Eqn . 2$$

$$i = 0 , 1 , … , {2}^{A} - 1$$

where s (n) are the soft value.

The detected codeword is

$${i}_{max} = {argmax}_{i} \{ {d}_{i} \} ,$$

the corresponding dᵢ is the best decoding metric, and denote it dₘₐₓ, and the second best codeword is found

$${i}_{sec} = {argmax}_{i \backslash \{ {i}_{max} \}} \{ {d}_{i} \}$$

by excluding the best codeword. Denote the second-best decoding metric as d_{sec}.

The tentatively decoded bits â(m) are given as the binary representation of the detected codewords: â(m), m=0, 1, . . . A−1 is the binary representation of iₘₐₓ.

For fast decoding, the above decoding process is normally replaced by fast Hadamard transformation decoder.

When the HARQ feedback bits are decoded as outlined above, we shall meet the 3GPP requirements, ack missed to be 1%, BLER to be 1%, DTX to ack to be 1% and Nack2Ack to be 0.1%.

The best decoding performance can be achieved if all target SNR's (Signal to Noise Ratio) can be met at the same SNR value, and we do not have the imbalance issue. The current commonly used small block decoder has this imbalance issue.

FIG. 1A depicts nack2ack decoding issues with a normal speed UE, while FIG. 1B depicts nack2ack decoding issues with a highspeed UE.

The horizontal axes in FIGS. 1A and 1B are the number of HARQ feedback bits, while the vertical axis is the target SNR's to meet 1% BLER 106, 1% ackmiss 104 and 0.1% nack2ack 102.

FIG. 1A shows from 7 to 11 HARQ feedback bits with normal UE speed, nack2ack 102 is on a critical path and will cause a decoding issue (0.1% nack2ack) at a higher SNR than the 1% ackmiss rate 104. The nack2ack target SNR is generally below other targets (ackmiss 104 and BLER 106) SNR's. In FIG. 1B, the nack2ack (102) 0.1% error rate is at a higher SNR than the ackmiss (104) 1% error rate at all number of bits except for 3 for a high speed train UE.

Nack2Ack decoding errors have a higher impact than ackmiss 104 and BLER 106 because it will cause PDSCH Transport Block (TB) transmission to be terminated even if the TB transmission is still needed to be retransmitted. This behavior will cause upper layers (Radiolink Control (RLC) ARQ or applications) retransmission and long packet delays and will drag down PDSCH throughput significantly and waste airlink resources.

### SUMMARY

Various embodiments described herein provide for improvements to the small block decoder used for format 3 Physical Uplink Control Channel (PUCCH) decoding for 3 to 11 bits to improve the Physical Downlink Shared Channel (PDSCH) throughput. Two decoding metrics are used to control the downlink (DL) Hybrid Automatic Repeat Request (HARQ) bits decoding performance related to Block Error Rate (BLER), ackmiss, nack2ack, and dtx2ack, to align the 1% ackmiss target signal to noise ratio (SNR) with 0.1% nack2ack SNR value. By presimulating the decoding metric thresholds, the nack2ack SNR value to meet the 0.1% requirement will be significantly reduced.

In an embodiment, a method can be provided by a base station for improving PDSCH throughput. The method can include receiving a PUCCH, transmission from a wireless communication device over a wireless channel from the wireless communication device to the base station. The method can include decoding the received PUCCH transmission with a first value of a function of the PUCCH transmission corresponding to a codeword of a codebook, wherein the first value is a maximum value of the function. The method can include decoding the received PUCCH transmission with a second value of the function of the PUCCH transmission corresponding to another codeword of the codebook, wherein the second value is a next highest value of the function after the first value, and wherein a first decoding metric is the first value of the function, and a second decoding metric is a difference between the first value of the function and the second value of the function. The method can include determining that the PUCCH transmission is discontinuous transmission (DTX) true in response to either the first decoding metric being below a first decoding metric threshold, or the second decoding metric being below a second decoding metric threshold. The method can include determining that the PUCCH transmission is DTX false in response to both the first decoding metric being equal to or above the first decoding metric threshold, and the second decoding metric being equal to or above the second decoding metric threshold. The method can include performing a HARQ process operation based on whether the PUCCH transmission is DTX true or DTX false.

In another embodiment, the first value of the function is a scalar product of rate de-matched soft values of the PUCCH transmission and the codeword. In another embodiment, the second value of the function is a scalar product of rate de-matched soft values of the PUCCH transmission and the other codeword.

In another embodiment, the determining the first value and the second value can include determining the scalar products of rate de-matched soft values of the PUCCH transmission and each codeword in the codebook.

In an embodiment, the PUCCH transmission comprises HARQ bits associated with a PDSCH transmission.

In an embodiment, the first decoding metric threshold and the second decoding metric threshold are pre-simulated.

In an embodiment, the second decoding metric threshold is selected first such that a first SNR associated with a 1% acknowledgement miss rate is equal to or higher than a second SNR associated with a 0.1% false acknowledgment rate, then the first decoding metric threshold is selected or simulated such that false detection rate (DTX to Acknowledgement rate) is less than 1% in conjunction with the second metric threshold.

In an embodiment, a speed of a UE; whether frequency hopping is enabled; and whether the PUCCH transmission is demodulated using Maximum Ratio Combining (MRC) or Interference Rejection Combining (IRC) demodulation.

In an embodiment, the first decoding metric threshold is selected based on: a number of bits in the PUCCH transmission; a speed of the UE; whether frequency hopping is enabled; and whether the PUCCH transmission is demodulated using MRC or IRC demodulation.

In another embodiment, base station is provided that is configured to improve PDSCH throughput, the base station can comprise a radio interface and processing circuitry configured to receive a PUCCH transmission from a wireless communication device over a wireless channel from the wireless communication device to the base station. The processing circuitry can also decode the received PUCCH transmission with a first value of a function of the PUCCH transmission corresponding to a codeword of a codebook, wherein the first value is a maximum value of the function. The processing circuitry can also decode the received PUCCH transmission with a second value of the function of the PUCCH transmission corresponding to another codeword of the codebook, wherein the second value is a next highest value of the function after the first value, and wherein a first decoding metric is the first value of the function, and a second decoding metric is a difference between the first value of the function and the second value of the function. The processing circuitry can also determine that the PUCCH transmission is DTX true in response to either the first decoding metric being below a first decoding metric threshold, or the second decoding metric being below a second decoding metric threshold. The processing circuitry can also determine that the PUCCH transmission is DTX false in response to both the first decoding metric being equal to or above the first decoding metric threshold, and the second decoding metric being equal to or above the second decoding metric threshold. The processing circuitry can also perform a HARQ process operation based on whether the PUCCH transmission is DTX true or DTX false.

In another embodiment, a non-transitory computer readable-medium is provided that includes instructions stored thereon, that when implemented by a processor perform operations for improving PDSCH throughput, the operations comprising receiving a PUCCH transmission from a wireless communication device over a wireless channel from the wireless communication device to a base station. The operations can also comprise decoding the received PUCCH transmission with a first value of a function of the PUCCH transmission corresponding to a codeword of a codebook, wherein the first value is a maximum value of the function. The operations can also comprise decoding the received PUCCH transmission with a second value of the function of the PUCCH transmission corresponding to another codeword of the codebook, wherein the second value is a next highest value of the function after the first value, and wherein a first decoding metric is the first value of the function, and a second decoding metric is a difference between the first value of the function and the second value of the function. The operations can also comprise determining that the PUCCH transmission is DTX true in response to either the first decoding metric being below a first decoding metric threshold, or the second decoding metric being below a second decoding metric threshold. The operations can also comprise determining that the PUCCH transmission is DTX false in response to both the first decoding metric being equal to or above the first decoding metric threshold, and the second decoding metric being equal to or above the second decoding metric threshold. The operations can also comprise performing a HARQ process operation based on whether the PUCCH transmission is DTX true or DTX false.

Certain embodiments may provide one or more of the following technical advantage(s). The second decoding metric can behave as a weak cyclic redundancy check (CRC) which can improve the small block HARQ feedback decoding quality. Another improvement is that nack2ack decoding performance can be improved between a half dB to 2 dB and nack2ack can be removed from gating or critical path, which can reduce false HARQ success (nack2ack) significantly and thus reduce higher layer retransmissions. Furthermore, by improving the small block decoding performance with different decoding metrics d_{delta} and dₘₐₓ, nack2ack and overall decoding reliability and performance will be achieved for small block decoder especially for bits from 7 to 11 for normal speed UE and for bits from 3 to 11 with highspeed train UE, and thus boosting PDSCH throughput significantly and reduce upper layer retransmissions and end-to-end packet latency. Another advantage is that cell coverage can be improved due to the improved decoding performance.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIGS. 1A and 1B illustrate graphs showing signal to noise ratio (SNR) values required to achieve the target nack2ack, ackmiss, and block error rate (BLER) targets for different numbers of bits for regular (1A) and highspeed (1B) User Equipments (UEs).

FIG. 2 illustrates one example of a cellular communications system in which embodiments of the present disclosure may be implemented.

FIG. 3 illustrates an exemplary receive chain of a base station device according to one or more embodiments of the present disclosure.

FIG. 4 illustrates a flowchart of a method for improving Physical Downlink Shared Channel (PDSCH) throughput according to one or more embodiments of the present disclosure.

FIGS. 5A-5C illustrate exemplary tables of presimulated decoding metric thresholds according to some embodiments of the present disclosure.

FIGS. 6A and 6B illustrate exemplary tables of presimulated decoding metric thresholds according to some embodiments of the present disclosure.

FIG. 7 illustrates an exemplary table of presimulated decoding metric thresholds according to some embodiments of the present disclosure.

FIG. 8 illustrates a graph showing nack2ack performance improvement relative to ackmiss and BLER improvements according to some embodiments of the present disclosure.

FIGS. 9A-9F illustrate graphs showing improvements to SNR values required to achieve the target nack2ack rates for different numbers of bits in different conditions according to some embodiments of the present disclosure.

FIG. 10 is a schematic block diagram of a radio access node according to some embodiments of the present disclosure.

FIG. 11 is a schematic block diagram that illustrates a virtualized embodiment of the radio access node according to some embodiments of the present disclosure.

FIG. 12 is a schematic block diagram of the radio access node according to some other embodiments of the present disclosure.

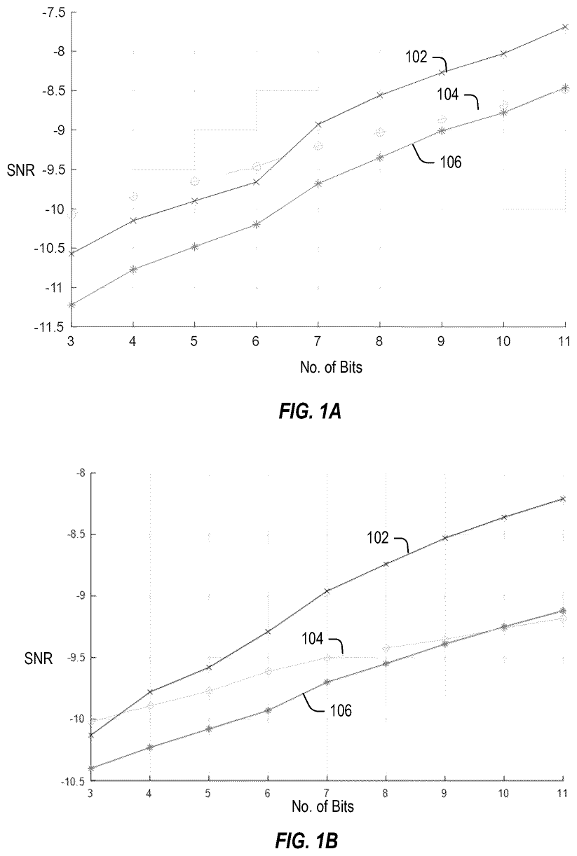

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Base Station Device: As used herein, a “base station device” is any node in a Radio Access Network (RAN) of a cellular communications network that operates to wirelessly transmit and/or receive signals. Some examples of a radio access node include, but are not limited to, a New Radio (NR) base station (gNB) in a Third Generation Partnership Project (3GPP) Fifth Generation (5G) NR network or an enhanced or evolved Node B (eNB) in a 3GPP Long Term Evolution (LTE) network, a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Various embodiments described herein provide for improvements to the small block decoder used for format 3 Physical Uplink Control Channel (PUCCH) decoding for 3 to 11 bits to improve the Physical Downlink Shared Channel (PDSCH) throughput. Two decoding metrics are used to control the downlink (DL) Hybrid Automatic Repeat Request (HARQ) bits decoding performance related to Block Error Rate (BLER), ackmiss, nack2ack, and dtx2ack, to align the 1% ackmiss target signal to noise ratio (SNR) with 0.1% nack2ack SNR value. By presimulating the decoding metric thresholds, the nack2ack SNR value to meet the 0.1% requirement will be significantly reduced.

Two decoding metrics dₘₐₓ and d_{delta}=(dₘₐₓ−d_{sec}) are used to control the DL HARQ bits decoding performance related to BLER, ackmiss, nack2ack, and dtx2ack.

As described above, for the detected codeword,

$${i}_{max} = {argmax}_{i} \{ {d}_{i} \} , {d}_{max}$$

is the corresponding dᵢ that is the best decoding metric. A second codeword from the codebook that returns the second best decoding metric is d_{sec}. The d_{delta} is thus the difference between decoding metrics associated with the best codeword and the second best codeword.

d_{delta} is used to align 1% ackmiss target SNR value with 0.1% nack2ack Signal to Noise ratio (SNR) value and try to make sure nack2ack is not gating (or on a critical path) compared against ackmiss target SNR value. This decoding metric behaves as a weak cyclic redundancy check (CRC) and improves required nack2ack target SNR significantly and the decoding reliability.

Through simulations, thresholds are found for dₘₐₓ and d_{delta}, they will be used in the decoding process.

Then dₘₐₓ and d_{delta} are used together with simulated thresholds to meet 1% dtx2ack, 1% ackmiss, 0.1% nack2ack and 1% BLER requirements. The nack2ack required SNR value to meet the 0.1% requirement can therefore be significantly reduced.

An improvement is found such that the needed target SNR to meet 0.1% nack2Ack is reduced while the 1% target ackmiss SNR will not be affected much, thus achieving decoding balance. To achieve that performance goal, dₘₐₓ and d_{delta}=(dₘₐₓ−d_{sec}) are used to control the alignment of target SNR's for BLER, nack2ack, ackmiss and discontinuous transmission (DTX) to ACK. Here d_{delta} plays a similar role as a weak CRC and controls the nack2ack rate. Simulations are done to find threshold tables to achieve the best decoding performance.

Certain embodiments may provide one or more of the following technical advantage(s). The decoding metrics can behave as a weak cyclic redundancy check (CRC) which can improve the small block HARQ feedback decoding quality. Another improvement is that nack2ack decoding performance can be improved between a half dB to 2 dB and nack2ack can be removed from gating, which can reduce false HARQ success (nack2ack) significantly and thus reduce higher (or upper) layer retransmissions. Furthermore, by improving the small block decoding performance with different decoding metrics d_{delta} and dₘₐₓ, nack2ack and overall decoding reliability and performance will be achieved for small block decoder especially for bits from 7 to 11 for normal speed UE and for bits from 3 to 11 with highspeed train UE, and thus boosting PDSCH throughput significantly and reduce upper layer retransmissions and end-to-end packet latency. Another advantage is that cell coverage can be improved due to the improved decoding performance.

In the present disclosure, the focus is on PUCCH Format3 small block decoding performance improvement of 3 to 11bits HARQ feedbacks without CRC protection from standard and how to use the results for PDSCH and Physical Downlink Control Channel (PDCCH) link adaptations. PDSCH uses ACK/NACK to do outer-loop adjustment while PDCCH uses DTX/non-DTX to do outer-loop adjustment. Furthermore, the methods and techniques disclosed herein can also be implemented for other PUCCH formats such as Format 4, and small block uplink control information (UCI) decoding on Physical Uplink Shared Channel. Additionally, the methods and techniques disclosed herein can also be used with cloud RAN and Open RAN.

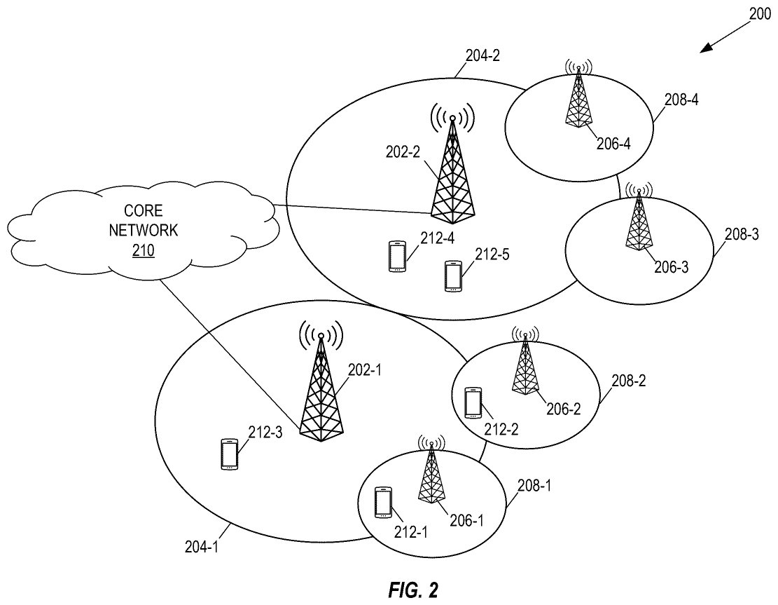

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 202-1 and 202-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

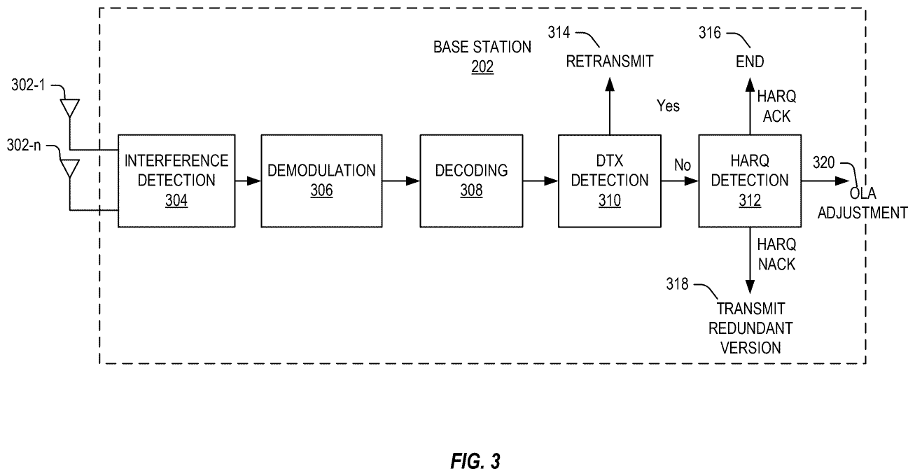

FIG. 3 illustrates an exemplary receive chain of a base station device 202 according to one or more embodiments of the present disclosure.

The base station device 202 can receive a PUCCH transmission from wireless communication device 212, at one or more of antennas 202-1 to 202-n. Interference detection 304 can be performed on the PUCCH transmission in order to determine whether to use Maximum Ratio Combining (MRC) or Interference Rejection Combining (IRC) demodulation.

After the received PUCCH transmission is demodulated at 306, the base station 202 can decode the PUCCH transmission at 308. In an embodiment, the PUCCH transmission can be decoded with a first value of a function of the PUCCH transmission corresponding to a codeword of a codebook, wherein the first value is a maximum value of the function. Then the received PUCCH transmission can also be decoded with a second value of the function of the PUCCH transmission corresponding to another codeword of the codebook, wherein the second value is a next highest value of the function after the first value, and wherein a first decoding metric is the first value of the function, and a second decoding metric is a difference between the first value of the function and the second value of the function.

DTX detection is then performed at 310 where it determines whether the PUCCH transmission is DTX true in response to either the first decoding metric being below a first decoding metric threshold, or the second decoding metric being below a second decoding metric threshold. The base station 202 can also determine whether the PUCCH transmission is DTX false in response to both the first decoding metric being equal to or above the first decoding metric threshold, and the second decoding metric being equal to or above the second decoding metric threshold.

The first decoding metric threshold is dₘₐₓ threshold entitled d_{max_thr}. The second decoding metric threshold is a d_{delta} threshold entitled d_{delta_thr}.

The first step is to find d_{delta} thresholds through simulations to make sure the 1% ackmiss target SNR and 0.1% nack2ack target SNR are aligned and meeting the following two conditions:

Condition 1:

SNR1% ackmiss≥SNR0.1% nack2ack Eqn. 3

And sweeping d_{delta_thr} to meet condition 1 requires the following decoding failures which are Condition 2:

if (d_{delta}<d_{delta_thr})DTX=TRUE. Otherwise, DTX=FALSE. Eqn. 4

The above condition 2 is like triggering a decoding failure as with CRC check.

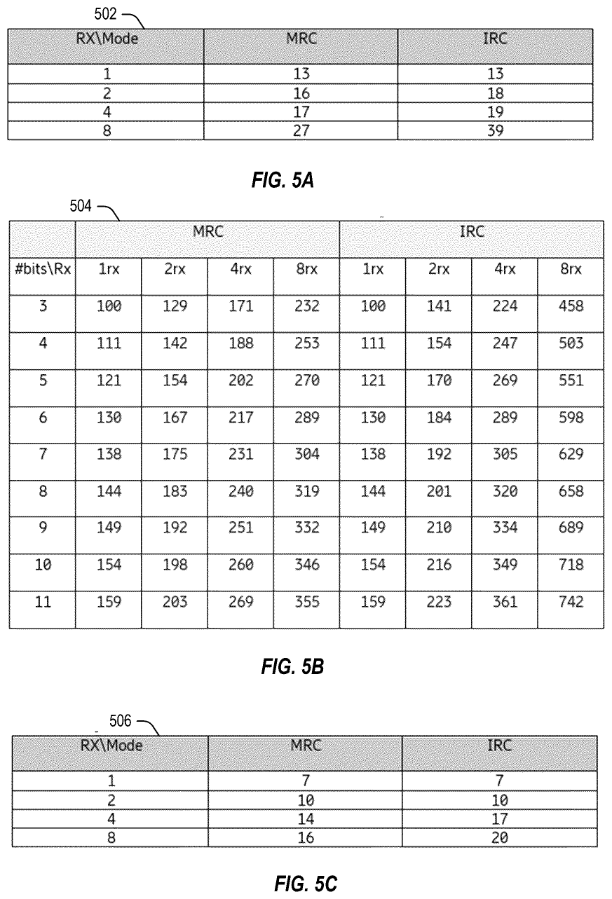

Based on simulations, example threshold table is found for d_{delta}, example thresholds for d_{delta} are shown in FIG. 5A with table 502 for a normal speed UE with frequency hopping (FH) configured.

The second step is to find dₘₐₓ thresholds through simulations. With applying the d_{delta} thresholds only and sweeping d_{max_thr} thresholds to meet 1% dtx2ack target:

if (dₘₐₓ<d_{max_thr})∥(d_{delta}<d_{delta_thr})DTX=TRUE. Otherwise, DTX=FALSE.

The thresholds for dₘₐₓ are derived through simulations and examples are in table 504 in FIG. 5B for a normal speed UE with frequency hopping configured.

Once the two thresholds are found, the above DTX detection equation will be used for DTX detection at 310.

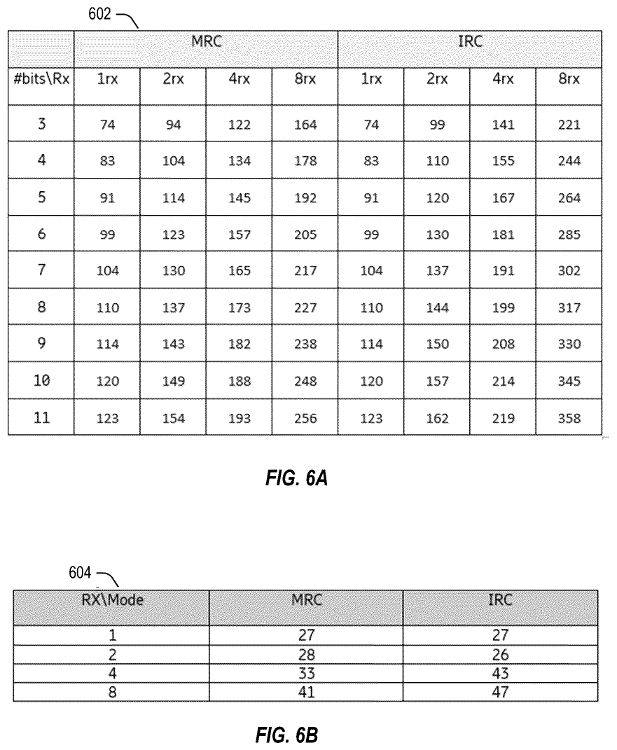

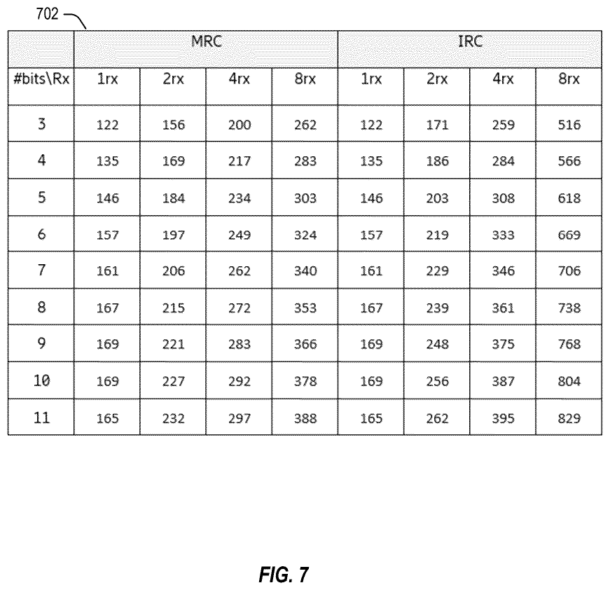

Table 506 in FIG. 5C is the d_{delta_thr} for Normal Speed UEs without FH while Table 602 in FIG. 6A is the d_{max_thr} for Highspeed UE with FH, table 604 in FIG. 6B is the d_{delta_thr} for Highspeed Train UE with FH, and table 702 in FIG. 7 is the d_{max_thr} for Highspeed UE with FH.

If either of the decoding metrics is below their respective thresholds, we consider it DTX true, which means that the UE 212 failed to decode the PDCCH transmission and didn't send the HARQ feedbacks to the base station 202. As a result, the base station 202 shall retransmit the same data packets at step 314 to the UE 212 with the same redundant version. If the decoding result is classified as successful (DTX false), it means that the UE 212 successfully decoded the PDCCH and sent its corresponding HARQ feedback, and HARQ detection is performed at 312. Based on the decoding result, base station 202 will perform the following process. If the HARQ feedback is NACK, its corresponding data packet will be retransmitted with a different redundant version at step 318. If it is ACK, the base station 202 knows that the UE 212 successfully received the data packet and will remove it from the DL transmit buffer and terminate the HARQ process at step 316. The decoding result can also be used to make the outer-loop adjustment of PDSCH SINR and PDCCH SINR at step 320.

For PDSCH outer-loop adjustment, if the previous transmission's HARQ feedback is not DTX and the decoded bit is ACK, the PDSCH SINR are increased by an amount defined as UP_STEP. So, the SINR adjustment will be:
OL_ADJ+=UP_STEP

If the decoded bit is NACK, the PDSCH SINR is decreased by an amount defined as DOWN_STEP. So, the SINR adjustment will be:
OL_ADJ−=DOWN_STEP

If the previous transmission HARQ feedback is classified as either a DTX or “unknown”, no action is required for PDSCH outer loop adjustment.

The ratio of the UP_STEP and DOWN_STEP is determined based on the desired BLER target in percentage (or the PDSCH transmission failure rate)
DOWN_STEP/UP_STEP=100/BLER_TARGET−1

The DOWN_STEP value can be tuned to have the desired outer-loop convergence speed. BLER_TARGET can be pre-determined, e.g., 10%.

For PDCCH outer-loop adjustment, if DTX is not detected, it means that the UE has successfully decoded the PDCCH. The PDCCH SINR is increased by an amount defined as UP_STEP. So, the SINR adjustment will be:
OL_ADJ+=UP_STEP

If DTX is detected, the PDCCH SINR is decreased by an amount defined as DOWN_STEP. So, the SINR adjustment will be:
OL_ADJ−=DOWN_STEP

The ratio of the UP_STEP and DOWN_STEP can be tuned based on some different operating target criteria and depending on applications.

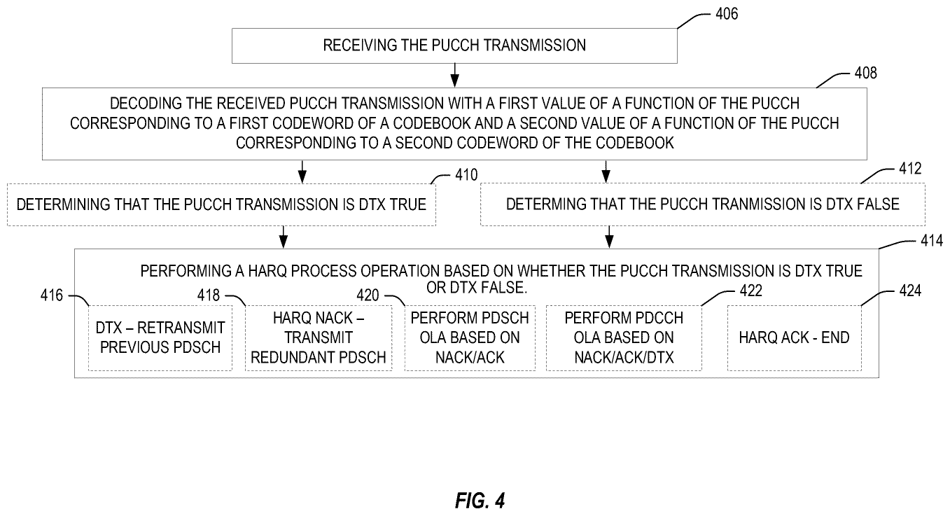

FIG. 4 illustrates a flowchart of a method for improving Physical Downlink Shared Channel (PDSCH) throughput according to one or more embodiments of the present disclosure.

FIG. 4 can start at step 406, where the method includes receiving a PUCCH transmission from a wireless communication device over a wireless channel from the wireless communication device to the base station.

At step 408, the method can include decoding the received PUCCH transmission with a first value of a function of the PUCCH transmission corresponding to a codeword of a codebook, wherein the first value is a maximum value of the function. Step 408 can also include decoding the received PUCCH transmission with a second value of the function of the PUCCH transmission corresponding to another codeword of the codebook, wherein the second value is a next highest value of the function after the first value, and wherein a first decoding metric is the first value of the function, and a second decoding metric is a difference between the first value of the function and the second value of the function.

In an embodiment, the first value of the function is a scalar product of rate de-matched soft values of the PUCCH transmission and the codeword. In an embodiment, the second value of the function is a scalar product of rate de-matched soft values of the PUCCH transmission and the other codeword.

In an embodiment, determining the first value of the function and the second value of the function comprises determining the scalar products of rate de-matched soft values of the PUCCH transmission and each codeword in the codebook.

In an embodiment, the PUCCH transmission comprises HARQ bits associated with a PDSCH transmission.

The method can continue at step 410, where the method optionally includes determining that the PUCCH transmission is DTX true in response to either the first decoding metric being below a first decoding metric threshold, or the second decoding metric being below a second decoding metric threshold.

At step 412, the method optionally includes determining that the PUCCH transmission is DTX false in response to both the first decoding metric being equal to or above the first decoding metric threshold, and the second decoding metric being equal to or above the second decoding metric threshold.

In an embodiment, the first decoding metric threshold and the second decoding metric threshold are pre-simulated.

In an embodiment, the second decoding metric threshold is selected first such that a first signal to noise ratio, SNR, associated with a 1% acknowledgement miss rate is equal to or higher than a second SNR associated with a 0.1% false acknowledgment rate, then the first decoding metric threshold is selected or simulated such that false detection rate (e.g., a DTX to Acknowledgement rate) is less than 1% in conjunction with the second metric threshold.

In an embodiment, the first decoding metric threshold is selected based on: a number of bits, a speed of a UE, whether frequency hopping is enabled, and whether the PUCCH transmission is demodulated using MRC or IRC demodulation.

At step 414, the method can include performing (414) a HARQ process operation based on whether the PUCCH transmission is DTX true or DTX false.

The performing the HARQ process operation can include providing (416) to a base station scheduler a request to retransmit the PDSCH transmission if the PUCCH transmission is DTX true.

In response to the received PUCCH being DTX false, performing (418, 424) HARQ detection on the PDSCH transmission. If the HARQ detection is negative, at step 418, the method can include providing to a base station scheduler a request to transmit a redundant PDSCH. If the HARQ detection is positive, at step 424, the method can include ending the HARQ process.

At step 420, the method includes performing a PDSCH outer-loop adjustment based on the at least one of the HARQ ACK or NACK. At step 422, the method includes performing (422) a PDCCH outer-loop adjustment based on at least one of the HARQ ACK, HARQ NACK, or whether DTX is true or false.

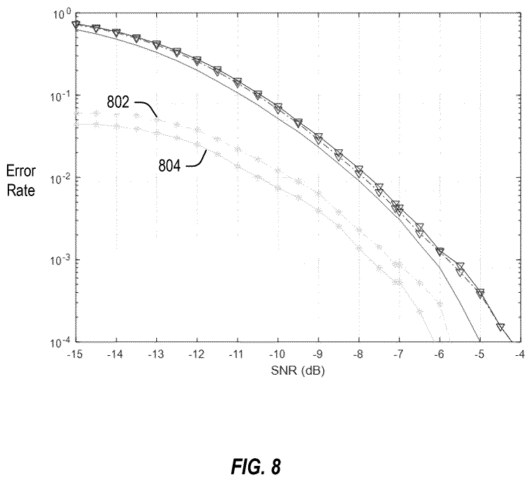

FIG. 8 illustrates a graph showing nack2ack performance improvement relative to ackmiss and BLER improvements according to some embodiments of the present disclosure.

In FIG. 8, the y-axis denotes the percent of nack2ack, ackmiss, and BLER over the x-axis of SNR. The line 802 is a baseline nack2ack and line 804 is the improved nack2ack after the improvements due to the techniques disclosed herein. There is a clear lowering of the SNR for the line 804 at every SNR point.

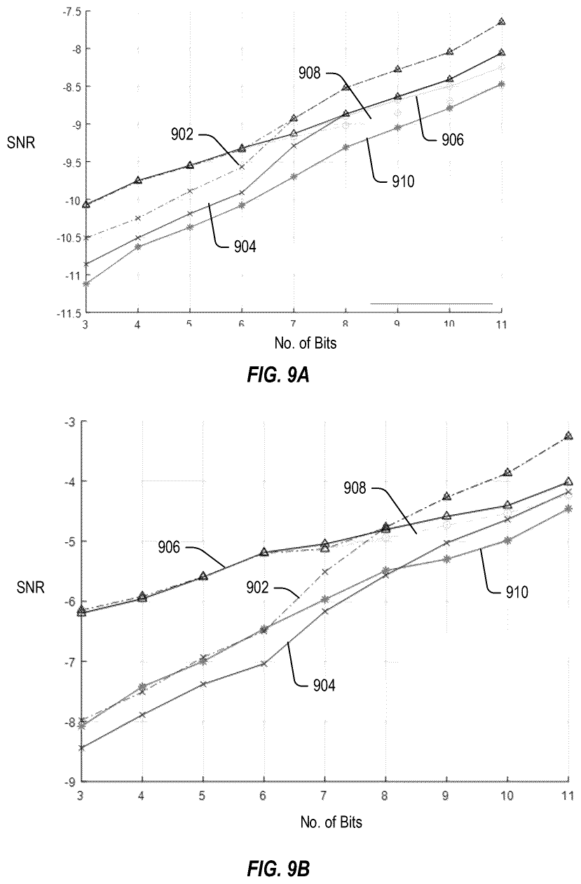

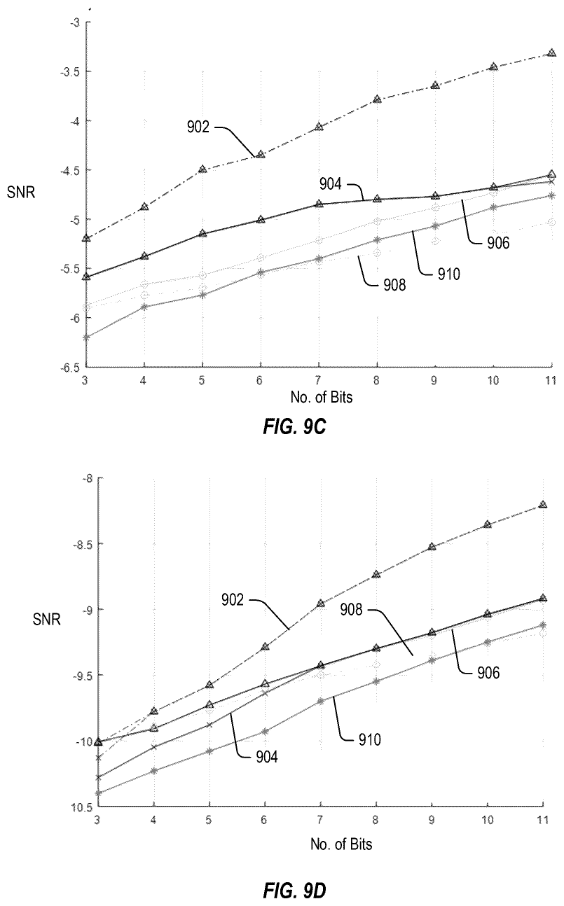

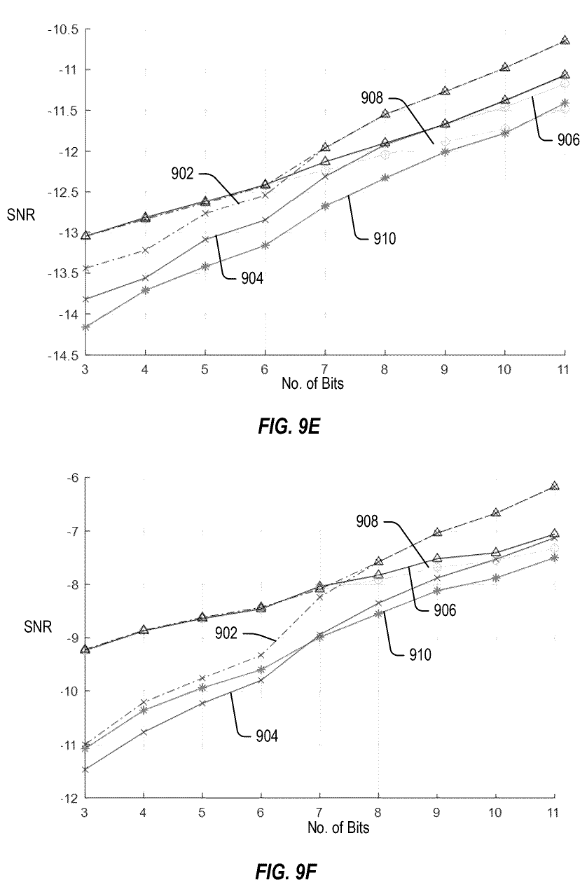

FIGS. 9A-9F illustrate graphs showing improvements to SNR values required to achieve the target nack2ack rates for different numbers of bits in different conditions according to some embodiments for the present disclosure. In each of FIGS. 9A-9F, the y-axis is target SNR, and the x-axis is number of HARQ bits, and the lines represent the SNR required to achieve the target BLER, ackmiss, and nack2ack miss rates of 1%, 1%, and 0.1% respectively. For example, in each of FIGS. 9A-9F, 902 is the baseline nack2ack, 904 is the improved nack2ack, 908 is the baseline ackmiss, 906 is the improved ackmiss, and 910 is the BLER. As can be seen in the figures, after the improvements, the improved nack2ack 904 is closer to, or does not exceed the SNR required to achieve the target ackmiss.

FIG. 9A represents the Additive White Gaussian Noise (AWGN) channel decoding nack2ack error improvement. FIG. 9B is the TDLC Channel nack2ack error improvement. FIG. 9C is the 1 Rx Nack2ack improvement for a highspeed train UE. FIG. 9D is the 4Rx Nack2ack improvement for a highspeed train UE. FIG. 9E shows the improvements in nack2ack for a midband 4Rx non-frequency hopping AWGN channel. FIG. 9F shows the improvements in nack2ack for a midband 4Rx non-frequency hopping TLDC channel.

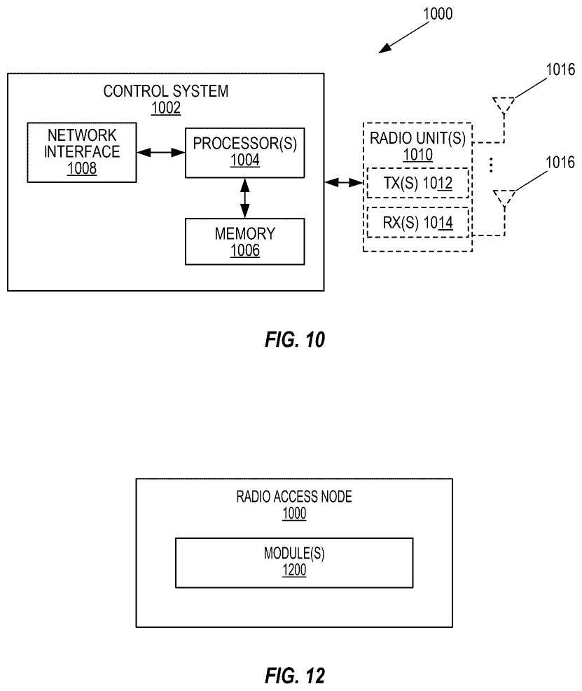

FIG. 10 is a schematic block diagram of a radio access node 1000 according to some embodiments of the present disclosure. Optional features are represented by dashed boxes. The radio access node 1000 may be, for example, a base station 202 or 206 or a network node that implements all or part of the functionality of the base station 202 or gNB described herein. As illustrated, the radio access node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the radio access node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 as described herein. In some embodiments, the function(s) are implemented in software that is stored, e.g., in the memory 1006 and executed by the one or more processors 1004.

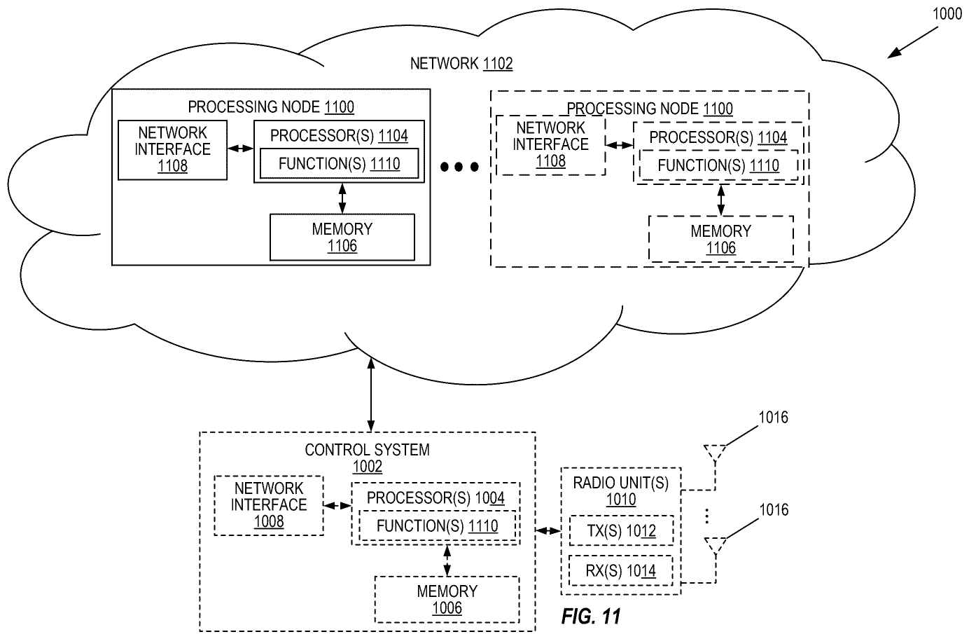

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 may include the control system 1002 and/or the one or more radio units 1010, as described above. The control system 1002 may be connected to the radio unit(s) 1010 via, for example, an optical cable or the like. The radio access node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the radio access node 1000 described herein are implemented at the one or more processing nodes 1100 or distributed across the one or more processing nodes 1100 and the control system 1002 and/or the radio unit(s) 1010 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

1. A method performed by a base station for improving Physical Downlink Shared Channel, PDSCH, throughput, the method comprising:
receiving a Physical Uplink Control Channel, PUCCH, transmission from a wireless communication device over a wireless channel from the wireless communication device to the base station;
decoding the received PUCCH transmission with a first value of a function of the PUCCH transmission corresponding to a codeword of a codebook, wherein the first value is a maximum value of the function;
decoding the received PUCCH transmission with a second value of the function of the PUCCH transmission corresponding to another codeword of the codebook, wherein the second value is a next highest value of the function after the first value, and wherein a first decoding metric is the first value of the function, and a second decoding metric is a difference between the first value of the function and the second value of the function;
determining that the PUCCH transmission is discontinuous transmission, DTX, true in response to either the first decoding metric being below a first decoding metric threshold, or the second decoding metric being below a second decoding metric threshold;
determining that the PUCCH transmission is DTX false in response to both the first decoding metric being equal to or above the first decoding metric threshold, and the second decoding metric being equal to or above the second decoding metric threshold; and
performing a Hybrid Automatic Repeat Request, HARQ, process operation based on whether the PUCCH transmission is DTX true or DTX false.

2. The method of claim 1, wherein the first value of the function is a scalar product of rate de-matched soft values of the PUCCH transmission and the codeword.

3. The method of claim 1, wherein the second value of the function is a scalar product of rate de-matched soft values of the PUCCH transmission and the other codeword.

4. The method of claim 3, wherein the determining the first value of the function and the second value of the function comprises:
determining the scalar products of rate de-matched soft values of the PUCCH transmission and each codeword in the codebook.

5. The method of claim 1, wherein the PUCCH transmission comprises HARQ bits associated with a PDSCH transmission.

6. The method of claim 1, wherein the first decoding metric threshold and the second decoding metric threshold are pre-simulated.

7. The method of claim 1, wherein the second decoding metric threshold is selected first such that a first signal to noise ratio, SNR, associated with a 1% acknowledgement miss rate is equal to or higher than a second SNR associated with a 0.1% false acknowledgment rate, then the first decoding metric threshold is selected or simulated such that false detection rate (DTX to Acknowledgement rate) is less than 1% in conjunction with the second metric threshold.

8. The method of claim 1, wherein the first decoding metric threshold is selected based on:
a speed of a User Equipment, UE;
whether frequency hopping is enabled; and
whether the PUCCH transmission is demodulated using Maximum Ratio Combining, MRC, or Interference Rejection Combining, IRC demodulation.

9. The method of claim 1, wherein performing the HARQ process operation further comprises:
in response to the PUCCH being DTX true, providing to a base station scheduler a request to retransmit the PDSCH transmission;
in response to the received PUCCH being DTX false, performing HARQ detection on the PDSCH transmission.

10. The method of claim 1, wherein the PDSCH transmission from base station comprises at least one of a HARQ Acknowledgement, ACK, or Negative ACK, NACK.

11. The method of claim 10, wherein performing the HARQ process operation further comprises:
performing a PDSCH outer-loop adjustment based on the at least one of the HARQ ACK or NACK; and
performing a Physical Downlink Control Channel, PDCCH, outer-loop adjustment based on at least one of the HARQ ACK, HARQ NACK, or whether DTX is true or false.

12. A base station configured to improve Physical Downlink Shared Channel, PDSCH, throughput, base station comprising a radio interface and processing circuitry configured to:
receive a Physical Uplink Control Channel, PUCCH, transmission from a wireless communication device over a wireless channel from the wireless communication device to the base station;
decode the received PUCCH transmission with a first value of a function of the PUCCH transmission corresponding to a codeword of a codebook, wherein the first value is a maximum value of the function;
decode the received PUCCH transmission with a second value of the function of the PUCCH transmission corresponding to another codeword of the codebook, wherein the second value is a next highest value of the function after the first value, and wherein a first decoding metric is the first value of the function, and a second decoding metric is a difference between the first value of the function and the second value of the function;
determine that the PUCCH transmission is discontinuous transmission, DTX, true in response to either the first decoding metric being below a first decoding metric threshold, or the second decoding metric being below a second decoding metric threshold;
determine that the PUCCH transmission is DTX false in response to both the first decoding metric being equal to or above the first decoding metric threshold, and the second decoding metric being equal to or above the second decoding metric threshold; and
perform a Hybrid Automatic Repeat Request, HARQ, process operation based on whether the PUCCH transmission is DTX true or DTX false.

13. The base station of claim 12, wherein the first value of the function is a scalar product of rate de-matched soft values of the PUCCH transmission and the codeword.

14. The base station of claim 12, wherein the second value of the function is a scalar product of rate de-matched soft values of the PUCCH transmission and the other codeword.

15. The base station of claim 14, wherein the processing circuitry is further configured to:
determine the scalar products of rate de-matched soft values of the PUCCH transmission and each codeword in the codebook.

16. The base station of claim 12, wherein the PUCCH transmission comprises HARQ bits associated with a PDSCH transmission.

17. The base station of claim 13, wherein the first decoding metric threshold and the second decoding metric threshold are pre-simulated.

18. The base station of claim 12, wherein the second decoding metric threshold is selected or simulated first such that a first signal to noise ratio, SNR, associated with a 1% acknowledgement miss rate is equal to or higher than a second SNR associated with a 0.1% false acknowledgment rate, then the first metric threshold is selected or simulated with the second threshold in use to meet 1% false detection rate (DTX to acknowledgement rate).

19. The base station of claim 12, wherein the first decoding metric threshold is selected based on:
a number of PDSCH HARQ feedback bits in the PUCCH transmission;
a speed of a User Equipment, UE;
whether frequency hopping is enabled; and
whether the PUCCH transmission is demodulated using Maximum Ratio Combining, MRC, or Interference Rejection Combining, IRC demodulation.

20-22. (canceled)

23. A non-transitory computer-readable medium comprising instructions stored thereon, that when implemented by a processor perform operations for improving Physical Downlink Shared Channel, PDSCH, throughput, the operations comprising:
receiving a Physical Uplink Control Channel, PUCCH, transmission from a wireless communication device over a wireless channel from the wireless communication device to a base station;
decoding the received PUCCH transmission with a first value of a function of the PUCCH transmission corresponding to a codeword of a codebook, wherein the first value is a maximum value of the function;
decoding the received PUCCH transmission with a second value of the function of the PUCCH transmission corresponding to another codeword of the codebook, wherein the second value is a next highest value of the function after the first value, and wherein a first decoding metric is the first value of the function, and a second decoding metric is a difference between the first value of the function and the second value of the function;
determining that the PUCCH transmission is discontinuous transmission, DTX, true in response to either the first decoding metric being below a first decoding metric threshold, or the second decoding metric being below a second decoding metric threshold;
determining that the PUCCH transmission is DTX false in response to both the first decoding metric being equal to or above the first decoding metric threshold, and the second decoding metric being equal to or above the second decoding metric threshold; and
performing a Hybrid Automatic Repeat Request, HARQ, process operation based on whether the PUCCH transmission is DTX true or DTX false.
